(19) United States
(12) Patent Application Publication
(10) Pub. No.: US 2026/0153887 A1
(43) Pub. Date: Jun. 4, 2026

(54) INFORMATION PROCESSING METHOD, INFORMATION PROCESSING DEVICE, AND RECORDING MEDIUM

(71) Applicant: Panasonic Intellectual Property Management Co, Ltd., Osaka (JP)

(72) Inventors: Takumi TONOIKE, Osaka (JP); Shunsuke KUHARA, Osaka (JP); Toshiya ARAI, Osaka (JP); Hirokazu KAWAMOTO, Osaka (JP); Toshihiko KUSAKABE, Osaka (JP); Yuki YAMADA, Osaka (JP)

(21) Appl. No.: 19/459,355

(22) Filed: Jan. 26, 2026

Related U.S. Application Data
(63) Continuation of application No. PCT/JP2024/025270, filed on Jul. 12, 2024.

(30) Foreign Application Priority Data
Aug. 14, 2023 (JP) 2023-132088

(51) Int. Cl. G05D 1/698; G05D 1/221; G05D 109/10

(52) U.S. Cl. CPC G05D 1/6983; G05D 1/221; G05D 1/6987; G05D 2109/10

(57) ABSTRACT

An information processing method includes: obtaining remote response requests for a plurality of mobile bodies; obtaining a response required time period and a response completion due time for each of two or more remote response requests that have not been responded to among the remote response requests; determining, for each of the two or more remote response requests, existence or non-existence of a remote response order in which a remote response to the remote response request can be completed by the response completion due time corresponding to the remote response; and executing, when the remote response order is determined to exist, a predetermined process on the two or more remote response requests based on the remote response order.

### CROSS REFERENCE TO RELATED APPLICATIONS

This is a continuation application of PCT International Application No. PCT/JP 2024/025270 filed on Jul. 12, 2024, designating the United States of America, which is based on and claims priority of Japanese Patent Application No. 2023-132088 filed on Aug. 14, 2023. The entire disclosures of the above-identified applications, including the specifications, drawings and claims are incorporated herein by reference in their entirety.

### FIELD

The present disclosure relates to an information processing method, an information processing device, and a recording medium.

### BACKGROUND

Patent Literature (PTL) 1 discloses a remote control device and an automatic driving system that suppress a decrease in safety of a vehicle capable of autonomous travel when an operator cannot intervene in the control of the vehicle.

### CITATION LIST

### Patent Literature

PTL 1: Japanese Unexamined Patent Application Publication No. 2020-154631

### SUMMARY

### Technical Problem

When one operator remotely controls a plurality of mobile bodies, the operator may be notified of a plurality of remote response requests. When each of the plurality of remote response requests has a completion time (response completion due time) for completing a corresponding remote response, it is desirable that one operator complete a remote response to each of the plurality of remote response requests by the completion time.

However, PTL 1 does not disclose a technique by which one operator completes a remote response to each of a plurality of remote response requests by the completion time.

Therefore, the present disclosure provides an information processing method, an information processing device, and a recording medium for assisting one operator in enabling a remote response to each of two or more remote response requests to be completed by a completion time.

### Solution to Problem

An information processing method according to one aspect of the present disclosure includes: obtaining remote response requests for a plurality of mobile bodies; obtaining a response required time period and a response completion due time for each of two or more remote response requests that have not been responded to; determining, for each of the two or more remote response requests, existence or non-existence of a remote response order in which a remote response to the remote response request can be completed by the response completion due time corresponding to the remote response request; and executing, when the remote response order is determined to exist, a predetermined process on the two or more remote response requests based on the remote response order.

An information processing device according to one aspect of the present disclosure includes: a first obtainer that obtains remote response requests for a plurality of mobile bodies; a second obtainer that obtains a response required time period and a response completion due time for each of two or more remote response requests that have not been responded to among the remote response requests; a determiner that determines, for each of the two or more remote response requests, existence or non-existence of a remote response order in which a remote response to the remote response request can be completed by the response completion due time corresponding to the remote response; and a controller that executes, when the remote response order is determined to exist, a predetermined process on the two or more remote response requests based on the remote response order.

A recording medium according to one aspect of the present disclosure is a non-transitory computer-readable recording medium having recorded thereon a program for causing a computer to execute the information processing method described above.

### Advantageous Effects

According to one aspect of the present disclosure, it is possible to implement an information processing method and the like capable of assisting one operator in enabling a remote response to each of two or more remote response requests to be completed by a completion time.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating a schematic configuration of an information processing system according to an embodiment.

FIG. 2 is a block diagram illustrating the functional configuration of the information processing system according to the embodiment.

FIG. 3 is a flowchart illustrating the operation of the information processing system according to the embodiment.

FIG. 4 is a diagram for describing a remote response order determination method when a plurality of remote responses can be completed only by remote responses from an operator.

FIG. 5 is a diagram for describing a remote response order determination method when a plurality of remote responses are simultaneously notified to the operator.

FIG. 6 is a diagram for describing an example of the remote response order determination method when vehicle control is performed.

FIG. 7 is a diagram for describing another example of the remote response order determination method when vehicle control is performed.

FIG. 8 is a diagram for describing a remote response order determination method when an on-call response request is issued.

FIG. 9 is a flowchart illustrating the operation of an information processing system according to a variation of the embodiment.

FIG. 10 is a diagram for describing a method of determining a readjusted remote response order.

FIG. 11 is a first diagram illustrating a display example of an operator terminal according to the embodiment and the like.

FIG. 12 is a second diagram illustrating a display example of the operator terminal according to the embodiment and the like.

FIG. 13 is a third diagram illustrating a display example of the operator terminal according to the embodiment and the like.

### DESCRIPTION OF EMBODIMENTS

### Circumstances Leading to the Present Disclosure

Circumstances leading to the present disclosure will be described before the description of an exemplary embodiment and the like of the present disclosure.

As described in “Technical Problem”, a remote control system in which one operator remotely controls a plurality of mobile bodies has been studied. For example, when a mobile body is unable to move autonomously, a remote control server notifies an operator of a remote response request. The remote response request is a request for an operator remotely located from the mobile body to remotely perform a response (for example, remote operation) related to movement of the mobile body.

When the operator receives the notification, the operator determines whether to perform response, determines the response timing, response content, and the like in the case of performing response, and then performs the remote response. For example, when the operator is notified of a plurality of remote response requests, the notifications of the plurality of remote response requests may be simultaneously displayed on a screen. As an operation flow in this case, the operator confirms the screen on which the notifications of the plurality of remote response requests are simultaneously displayed, determines a response order, and sequentially responds to each notification.

Here, a time period required for response (response required time period) and a time by which response completion is required (response completion due time) differ depending on the content of each remote response request. There are remote response requests each having a long or short response required time period, and a long (ahead) or short (near) response completion due time. For example, a remote response request having a short response required time period and a short response completion due time is exemplified by a request when a falling object is detected. An example of a remote response in this case is a vehicle stop instruction (for example, a temporary stop instruction). For example, a remote response request having a short response required time period and a long response completion due time is exemplified by a request for confirming a start of travel during return. An example of a remote response in this case is a travel start instruction. For example, a remote response request having a long response required time period and a short response completion due time is exemplified by a request in the case of being stuck on an obstacle. An example of a remote response in this case is avoidance by remote control (remote operation). For example, a remote response request having a long response required time period and a long response completion due time is exemplified by a request for remote control to a standby position after completion of service. An example of a remote response in this case is remote control to a standby position.

When a plurality of remote response requests having different response required time periods and response completion due times are displayed simultaneously as described above, the operator needs to determine a remote response order by himself or herself, which imposes a heavy burden on the operator. In addition, when the operator determines the remote response order by himself or herself, the operator may make a mistake in determining the remote response order. For example, it may occur that a remote response cannot be completed by the response completion due time. If a remote response cannot be completed by the response completion due time, a service provision time is delayed or safe operation is impeded. It is thus desirable to complete a remote response to each of the plurality of remote response requests by a corresponding response completion due time.

Therefore, the inventors of the present application have intensively studied an information processing method and the like capable of assisting one operator in enabling a remote response to each of two or more remote response requests to be completed by a corresponding response completion due time, and have conceived the information processing method and the like described below.

An information processing method according to a first aspect of the present disclosure includes: obtaining remote response requests for a plurality of mobile bodies; obtaining a response required time period and a response completion due time for each of two or more remote response requests that have not been responded to; determining, for each of the two or more remote response requests, existence or non-existence of a remote response order in which a remote response to the remote response request can be completed by the response completion due time corresponding to the remote response request; and executing, when the remote response order is determined to exist, a predetermined process on the two or more remote response requests based on the remote response order.

Thus, the predetermined process is executed on each of the two or more remote response requests that have not been responded to in a remote response order in which remote response to each of the two or more remote response requests can be completed by the response completion due time. Therefore, it is possible to implement an information processing method for assisting one operator in enabling a remote response to each of two or more remote response requests to be completed by a completion time (response completion due time).

For example, an information processing method according to a second aspect is the information processing method according to the first aspect, in which the two or more remote response requests may include a first remote response request and a second remote response request, and the information processing method may further include: obtaining a first response required time period and a first response completion due time for the first remote response request, and obtaining a second response required time period and a second response completion due time for the second remote response request; determining, based on a first time at which the first remote response request can be notified and the first response required time period, whether a remote response to the first remote response request can be completed by the first response completion due time; and determining, based on a second time at which the second remote response request can be notified and the second response required time period, whether a remote response to the second remote response request can be completed by the second response completion due time.

It is thus possible to assist in enabling a remote response to each of the first remote response request and the second remote response request to be completed by the response completion due time.

For example, an information processing method according to a third aspect is the information processing method according to the second aspect, in which the second response completion due time may be a time after the first response completion due time, and the second time may be a time specified based on the first time and the first response required time period.

Thus, when the remote operation for the first remote response request is performed and then the remote operation for the second remote response request is performed, it is possible to assist in enabling each remote response to be completed by the completion due time.

For example, an information processing method according to a fourth aspect is the information processing method according to the second aspect, and may further include: determining, when the remote response order is determined to exist, existence or non-existence of remote response requests in the remote response order that can be swapped earlier or later; and executing, when remote response requests that can be swapped earlier or later are determined to exist, the predetermined process simultaneously on the remote response requests that can be swapped earlier or later.

Thus, when there are remote response requests having a response order that can be swapped earlier or later, the operator is enabled to determine which remote response is to be executed first.

For example, an information processing method according to a fifth aspect is the information processing method according to the fourth aspect, and may further include: determining that the first remote response request and the second remote response request can be swapped earlier or later, when a time is earlier than each of the first response completion due time and the second response completion due time, the time being based on a time at which each of the first remote response request and the second remote response request can be notified and on a time period that is a sum of the first response required time period and the second response required time period.

It is thus possible to determine whether the first remote response request and the second remote response request can be swapped earlier or later by using the first response required time period, the second response required time period, the first response completion due time, and the second response completion due time.

For example, an information processing method according to a sixth aspect is the information processing method according to any one of the first to fifth aspects, and may further include: transmitting, as the predetermined process, to a terminal device of an on-call staff member, a notification requesting an on-call response when the remote response order is determined not to exist.

Thus, even when it is difficult to complete a remote response to each of two or more remote response requests by the response completion due time based only on the remote response order, an on-call response is requested, thereby enabling an improvement in the certainty that the remote response can be completed by the response completion due time.

For example, an information processing method according to a seventh aspect is the information processing method according to any one of the first to fifth aspects, and may further include: determining, when the remote response order is determined not to exist, whether the remote response order exists assuming that predetermined vehicle control is performed on one or more mobile bodies among the plurality of mobile bodies; and executing, when the remote response order is determined to exist, the predetermined process for the two or more remote response requests and executing the predetermined vehicle control on the one or more mobile bodies, based on the remote response order.

Thus, even when it is difficult to complete a remote response to each of two or more remote response requests by the response completion due time based only on the remote response order, predetermined vehicle control is executed, thereby enabling an improvement in the certainty that the remote response can be completed by the response completion due time.

For example, an information processing method according to an eighth aspect is the information processing method according to the seventh aspect, and may further include: excluding, from remote response requests on which the predetermined process is to be performed, the remote request obtained from the one or more mobile bodies, and determining, based on the response required time period and the response completion due time for the remote response request for each of one or more other mobile bodies among the plurality of mobile bodies except for the one or more mobile bodies, existence or non-existence of the remote response order in which the remote response to the remote response request for each of the one or more other mobile bodies can be completed by the response completion due time for each of the one or more other mobile bodies.

Thus, whether the remote response order exists is determined by excluding the remote response request from the mobile body on which vehicle control is to be performed, thereby enabling an improvement in the certainty that the remote response can be completed by the response completion due time.

For example, an information processing method according to a ninth aspect is the information processing method according to the seventh or eighth aspect, and may further include: further obtaining the response completion due time for each of the one or more mobile bodies when the predetermined vehicle control is performed on the one or more mobile bodies, the response completion due time further obtained being later than the response completion due time when the predetermined vehicle control is not performed; and determining whether the remote response order exists based on the response completion due time further obtained for each of the one or more mobile bodies.

Thus, when the response completion due time for the remote response request from the mobile body can be delayed by vehicle control, it is possible to improve the certainty that the remote response can be completed by the response completion due time without excluding each of the two or more remote response requests.

For example, an information processing method according to a tenth aspect may be the information processing method according to any one of the seventh to ninth aspects, in which the predetermined vehicle control may include at least one of a route change instruction, a speed change instruction, or a stop instruction to the one or more mobile bodies.

Thus, at least one of the route change instruction, the speed change instruction, or the stop instruction can be used to exclude the remote response request from the remote response requests on which the predetermined process is to be executed or to delay the response completion due time.

For example, an information processing method according to an eleventh aspect is the information processing method according to any one of the seventh to tenth aspects, in which, assuming that the predetermined vehicle control is performed on the one or more mobile bodies, when the remote response order is determined not to exist, a notification requesting an on-call response may be transmitted to a terminal device of an on-call staff member as the predetermined process.

Thus, even when it is difficult to complete a remote response to each of two or more remote response requests by the response completion due time based only on the remote response order and the vehicle control, an on-call response is requested, thereby enabling a further improvement in the certainty that the remote response can be completed by the response completion due time.

For example, an information processing method according to a twelfth aspect is the information processing method according to any one of the second to fifth aspects, and may further include: further obtaining, when an order of the first remote response request and the second remote response request is determined as the remote response order, a third remote response request after the predetermined process has been executed on the first remote response request; obtaining a third response required time period and a third response completion due time for the third remote response request; and updating the remote response order based on the second response required time period, the second response completion due time, the third response required time period, and the third response completion due time.

Thus, when the third remote response request is additionally obtained, the remote response order is updated, so that it is possible to assist in enabling the remote operation for the third remote response request to be completed by the third response completion due time.

For example, an information processing method according to a thirteenth aspect is the information processing method according to any one of the first to twelfth aspects, in which the plurality of mobile bodies may include a mobile body configured to provide a predetermined service, and the two or more remote response requests may include a remote response request obtained from a server device that manages the predetermined service.

Thus, the remote response to the remote response request obtained from the server device managing the predetermined service can be completed by the response completion due time.

For example, an information processing method according to a fourteenth aspect is the information processing method according to any one of the first to thirteenth aspects, in which the two or more remote response requests may include a remote response request generated based on operation information of the plurality of mobile bodies.

Thus, a remote response to a remote response request generated based on operation information can be completed by the response completion due time.

For example, an information processing method according to a fifteenth aspect is the information processing method according to any one of the first to fourteenth aspects, in which the predetermined process may include a process for causing a terminal device of an operator to present, based on the remote response order, a notification of each of the two or more remote response requests.

It is thus possible to notify the operator of which remote response is to be performed next. Since the operator does not need to determine the remote response order, it is possible to prevent remote response from being executed in an order in which the remote response cannot be completed by the response completion due time due to a determination error of the operator.

An information processing device according to a sixteenth aspect includes: a first obtainer that obtains remote response requests for a plurality of mobile bodies; a second obtainer that obtains a response required time period and a response completion due time for each of two or more remote response requests that have not been responded to among the remote response requests; a determiner that determines, for each of the two or more remote response requests, existence or non-existence of a remote response order in which a remote response to the remote response request can be completed by the response completion due time corresponding to the remote response; and a controller that executes, when the remote response order is determined to exist, a predetermined process on the two or more remote response requests based on the remote response order. Further, a recording medium according to a seventeenth aspect is a non-transitory computer-readable recording medium having recorded thereon a program for causing a computer to execute the information processing method according to any one of the first to fifteenth aspects.

As a result, effects similar to those of the above information processing method are achieved.

Note that these general or specific aspects may be realized in a system, method, integrated circuit, computer program, or non-transitory recording medium such as a computer-readable compact disc read-only memory (CD-ROM) or may be realized in any combination of a system, method, integrated circuit, computer program, or recording medium. The program may be stored in advance on the recording medium, or may be supplied to the recording medium via a wide area network including the Internet.

Hereinafter, an embodiment and the like will be described in detail with reference to the drawings.

Note that the embodiment and the like described below show comprehensive or specific examples. Numerical values, shapes, components, the arrangement positions and connection modes of the components, steps, the order of the steps, and the like, which will be shown in the following embodiment, are only examples and are not intended to limit the present disclosure. Among the components in the following embodiment and the like, components not recited in the independent claims are described as optional components.

Each figure is a schematic diagram and is not necessarily strictly illustrated. Therefore, for example, the scale and the like of each figure do not necessarily coincide. In each figure, substantially identical components are denoted by the same reference numerals, and redundant descriptions are omitted or simplified.

In the present specification, terms indicating the relationship among elements such as simultaneous, numerical values, and numerical ranges are expressions that do not only express a strict meaning, but also include substantially equivalent ranges, for example, differences of a few percent (or, around 10%).

In the present specification, ordinal terms such as “first” and “second” are, unless otherwise specified, not intended to indicate the number or order of components, and are used for the purpose of avoiding confusion and distinguishing the same type of components.

### EMBODIMENT

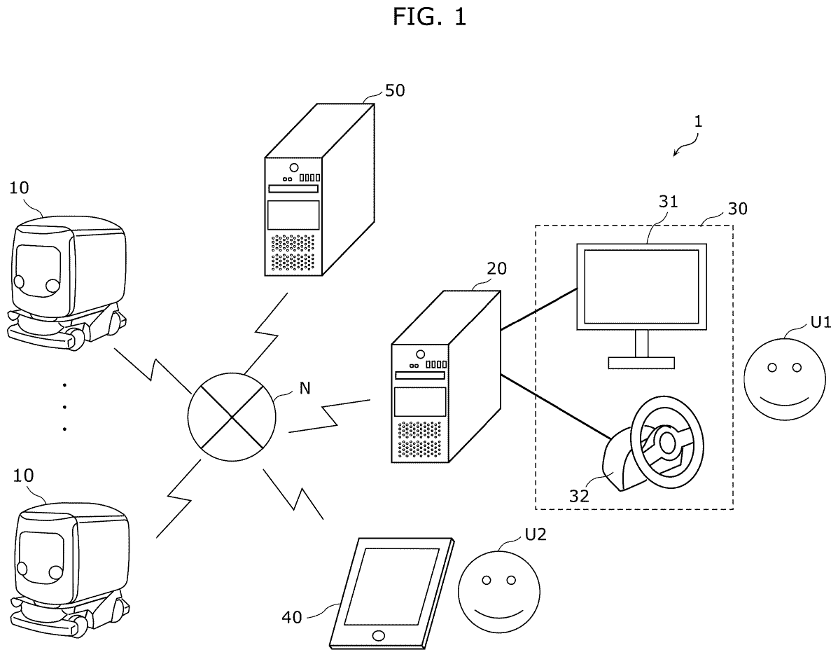

Hereinafter, an information processing method and the like according to the present embodiment will be described with reference to FIGS. 1 to 8.

### 1. Configuration of Information Processing System

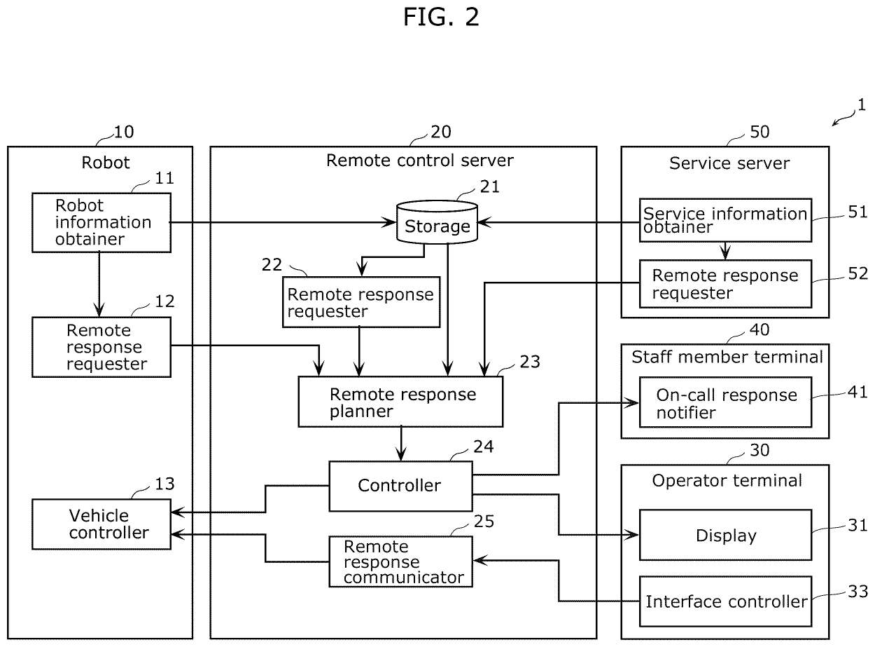

First, the configuration of an information processing system according to the present embodiment will be described with reference to FIGS. 1 and 2. FIG. 1 is a diagram illustrating a schematic configuration of information processing system 1 according to the present embodiment.

As illustrated in FIG. 1, information processing system 1 is a system for remotely controlling a plurality of robots 10, which can be robots to be operated, by one operator U1. The remote control includes remote monitoring and remote operation. The remote operation means that operator U1 instructs robot 10 to stop and start travel, controls acceleration and deceleration, controls steering angle, and the like via network N, as necessary.

Information processing system 1 includes remote control server 20 and operator terminal 30. Information processing system 1 may also include a plurality of robots 10, staff member terminal 40, and service server 50. When information processing system 1 includes robots 10, the number of robots 10 included in information processing system 1 is not particularly limited as long as the number is two or more. Information processing system 1 may include operator terminals 30 of a plurality of operators U1.

Remote control server 20 is a processing device that executes various processes for remote control of the plurality of robots 10 by one operator U1. Although described in detail later, remote control server 20 executes processes for assisting in completing a remote response to each of a plurality of remote response requests from the plurality of robots 10 by a corresponding response completion due time.

Remote control server 20 is installed at a place that can be communicatively connected to network N, and its physical position may be anywhere. As an example, when remote control server 20 is disposed in or near the space where operator terminal 30 is disposed, there is an advantage that communication with operator terminal 30 can be performed in a short time period. In addition, remote control server 20 is communicatively connected to the plurality of robots 10, staff member terminal 40, and service server 50 via network N.

FIG. 2 is a block diagram illustrating a functional configuration of information processing system 1 according to the present embodiment. FIG. 2 illustrates a functional configuration of only one robot 10 among the plurality of robots 10. The functional configuration of the other robots 10 may be similar to that of this one robot 10. In addition, FIG. 2 does not illustrate network N.

As illustrated in FIG. 2, robot 10 is a robot that can be subjected to remote control by operator U1. Robot 10 is a mobile body that can switch between autonomous travel and travel by remote operation. In the present embodiment, robot 10 includes an autonomous mobile robot capable of providing a predetermined service such as delivery. Robot 10 travels on a sidewalk, for example, but may travel on a roadway. Note that the mobile body may be, for example, a vehicle with or without a person on board, or a flying object such as a drone.

Robot 10 includes robot information obtainer 11, remote response requester 12, and vehicle controller 13.

Robot information obtainer 11 obtains robot information indicating the state of autonomously traveling robot 10 (the subject robot) from various sensors mounted on the subject robot to determine whether remote response is necessary for the subject robot. Robot 10 obtains image data, obtained by capturing surroundings of the subject robot, from one or more cameras (as examples of sensors) mounted on the subject robot. Robot information obtainer 11 obtains the following items from one or more sensors configured to detect the items: the speed, acceleration, jerk (rate of change of acceleration), and steering angle of the subject robot, the remaining battery power, the operating state of a direction indicator, the operating state of an anti-lock braking system (ABS) or an automatic emergency braking (AEB), the presence or absence, number, and type of surrounding objects, distance from surrounding objects, speed difference, or acceleration difference. Robot information obtainer 11 may include, for example, a communication circuit (communication module).

Robot information obtainer 11 outputs the obtained robot information to remote response requester 12. Robot information obtainer 11 transmits the obtained robot information to remote control server 20 via network N. Note that the robot information may include, for example, information indicating a traveling position and a travel route of robot 10.

Remote response requester 12 determines whether to request remote response from operator U1 based on the robot information obtained from robot information obtainer 11. Remote response requester 12 may determine whether to request remote response to robot 10 from operator U1 based on, for example, a first table in which the state of robot 10 indicated by the robot information is associated with information indicating whether to request remote response. Note that the method of determining whether to request remote response in remote response requester 12 is not limited to the method described above and may be performed by any known method. When remote response requester 12 determines to request remote response, remote response requester 12 transmits a remote response request to remote response planner 23.

Vehicle controller 13 performs vehicle control (for example, travel control) of robot 10 based on an instruction from remote control server 20. For example, vehicle controller 13 controls the speed, steering angle (traveling direction), and the like of the subject robot based on an instruction from remote control server 20.

Remote control server 20 is an example of an information processing device and includes storage 21, remote response requester 22, remote response planner 23, controller 24, and remote response communicator 25.

Storage 21 is a storage device for storing various types of information. Storage 21 stores robot information from robot 10 and service information from service server 50 received via a communication circuit (not illustrated). The service information is information related to a service performed by robot 10, and includes information such as a product delivery deadline time and information indicating whether robot 10 is in delivery or in return. The service information may further include a delivery destination (destination), and information indicating a product to be delivered. The robot information and the service information are periodically obtained and updated, for example. Storage 21 may be implemented by, for example, a semiconductor memory, but is not limited thereto.

Storage 21 stores remote control information required for remote control by operator U1. The remote control information may include operator information that includes the number of operators U1, the skill level and fatigue level of each operator U1, and correspondence information between operator terminal 30 and operator U1. The remote control information may include a second table to be described later. The remote control information may include the content of the remote response request, and information indicating whether vehicle control is possible, whether vehicle control can make remote response unnecessary. The remote control information may include vehicle control information that includes vehicle control candidates corresponding to the remote response request and the priority of execution of vehicle control for each vehicle control candidate. The vehicle control information may further include information indicating a time period by which the response completion due time for each vehicle control candidate can be delayed. The remote control information may include information indicating a response priority for an on-call response to each remote response request.

Note that the robot information, the service information, and the remote control information are collectively described as operation information.

The vehicle control is control for changing the travel conditions of robot 10 from the current traveling conditions in accordance with an instruction from remote control server 20, and includes at least one of an instruction for temporarily stopping robot 10 (stop instruction), an instruction for changing the speed of robot 10 (speed change instruction), or an instruction for changing the travel route of robot 10 (route change instruction). The vehicle control information may include information indicating that response cannot be performed by vehicle control in the case of being stuck on an obstacle or in another case.

Remote response requester 22 determines whether to request remote response to robot 10 from operator U1 based on operation information (for example, at least one of robot information or service information). Remote response requester 22 may determine whether to request remote response from operator U1 based on the first table in which the state of robot 10 indicated by at least one of the robot information or the service information is associated with information indicating whether to request remote response. Note that the method of determining whether to request remote response in remote response requester 22 is the method described above and may be performed by any known method. When remote response requester 22 determines to request remote response, remote response requester 22 outputs a remote response request to remote response planner 23.

Remote response planner 23 obtains a remote response request from any of remote response requesters 12, 22, 52. When a plurality of remote response requests are obtained, remote response planner 23 executes a process for completing a remote response to each of the plurality of remote response requests by the corresponding response completion due time. The plurality of remote response requests may include a remote response request obtained from remote response requester 12 of robot 10, a remote response request generated by remote response requester 22 based on the operation information of the plurality of robots 10, or a remote response request obtained from remote response requester 52 of service server 50.

When obtaining a new remote response request, remote response planner 23 adds the remote response request to a queue (storage area). That is, remote response planner 23 does not uniformly transfer a new remote response request to operator terminal 30 on every obtaining of a remote response request. Remote response planner 23 plans the order of notification of remote response requests such that all remote response requests included in the queue can be completed by the respective response completion due times. Although described in detail later, remote response planner 23 obtains a response required time period and a response completion due time for each remote response request, and determines a plan including the order of notification and timing for notification of the remote response requests to be notified to operator terminal 30 of operator U1 based on the obtained response required time period and response completion due time.

Based on the plan determined by remote response planner 23, controller 24 issues at least one of: notification of the remote response request to operator terminal 30 or to staff member terminal 40; or a vehicle control instruction to vehicle controller 13. When the remote response request is notified to operator terminal 30 of operator U1 or when the remote response to the notified remote response request is completed, controller 24 deletes the remote response request from the queue.

Based on a control signal for remote response received from operator terminal 30, remote response communicator 25 causes vehicle controller 13 to perform control related to the travel of robot 10. Remote response communicator 25 may include, for example, a communication circuit (communication module).

Operator terminal 30 is a terminal device used by operator U1 for implementing remote control by operator U1. Operator terminal 30 includes display 31, input component 32 (see FIG. 1), and interface controller 33.

Display 31 displays information related to remote control from remote control server 20. Display 31 displays, for example, a notification of a remote response request from remote control server 20. Display 31 may be implemented by, for example, a liquid crystal display device, but is not limited thereto. Operator terminal 30 may have a configuration that presents a notification by sound, light, or the like in place of display 31 or together with display 31.

Display 31 also displays information (for example, an image) indicating the surrounding situation of robot 10 when operator U1 remotely operates robot 10.

Input component 32 is connected to interface controller 33 and is a device to which various operations from operator U1 are input. Input component 32 is, for example, a steering wheel, a foot pedal (for example, an accelerator pedal and a brake pedal), or the like, and is a device for remotely operating robot 10.

Input component 32 may include a stop button for stopping robot 10, and a permission button for permitting robot 10 to start travel.

Note that input component 32 may be configured to accept input from operator U1 by voice, gesture, or the like.

Interface controller 33 is connected to input component 32 and transmits, to remote response communicator 25, information for remote response to robot 10 that has been input to input component 32. Interface controller 33 may include, for example, a communication circuit (communication module).

Staff member terminal 40 is a terminal device possessed by on-call staff member U2 who performs an action corresponding to the status of robot 10 in accordance with an instruction from on-call response notifier 41. On-call staff member U2 performs an action on robot 10 when a situation occurs that cannot be responded to by at least one of remote operation by operator U1 or vehicle control. On-call staff member U2 stands by at a place different from operator U1. On-call staff member U2 stands by in a plurality of standby areas, for example, and when an on-call response request is obtained, on-call staff member U2 in the nearest standby area promptly proceeds to the place where robot 10 requiring an on-call response is located and performs an action. It is assumed that on-call staff member U2 can complete an action by a response completion due time corresponding to a remote response request from robot 10.

Note that the on-call staff member may be a dedicated staff member or a general user who has contracted to perform an on-call response.

Staff member terminal 40 is implemented by a portable terminal such as a smartphone or a tablet terminal, or may be implemented by a stationary terminal such as a personal computer (PC). Staff member terminal 40 includes on-call response notifier 41.

On-call response notifier 41 notifies on-call staff member U2 of an on-call response request from controller 24. On-call response notifier 41 notifies on-call staff member U2 by, for example, display, sound, light, or the like, but the notification mode is not particularly limited.

Service server 50 is a server device for executing a process related to a predetermined service executed by robot 10. Service server 50 may include, for example, a server device managed by a service provider or the like that provides a predetermined service. Service server 50 includes service information obtainer 51 and remote response requester 52.

Service information obtainer 51 obtains service information related to a predetermined service executed by robot 10. Service information obtainer 51 is communicatively connected to a terminal device to which service information is input, and obtains, as service information, information input to the terminal device by an employee or a customer of the service provider. Service information obtainer 51 may include, for example, a communication circuit (communication module).

Remote response requester 52 determines whether to request remote response from operator U1 based on the service information obtained from service information obtainer 51. Remote response requester 52 may determine whether to request remote response from operator U1 based on, for example, a travel route of robot 10 specified by the service information and information indicating a section on the travel route in which autonomous travel is not possible. Note that the method of determining whether to request remote response in remote response requester 52 is the method described above and may be performed by any known method. When remote response requester 52 determines to request remote response, remote response requester 52 transmits the remote response request to remote response planner 23.

### 2. Operation of Information Processing System

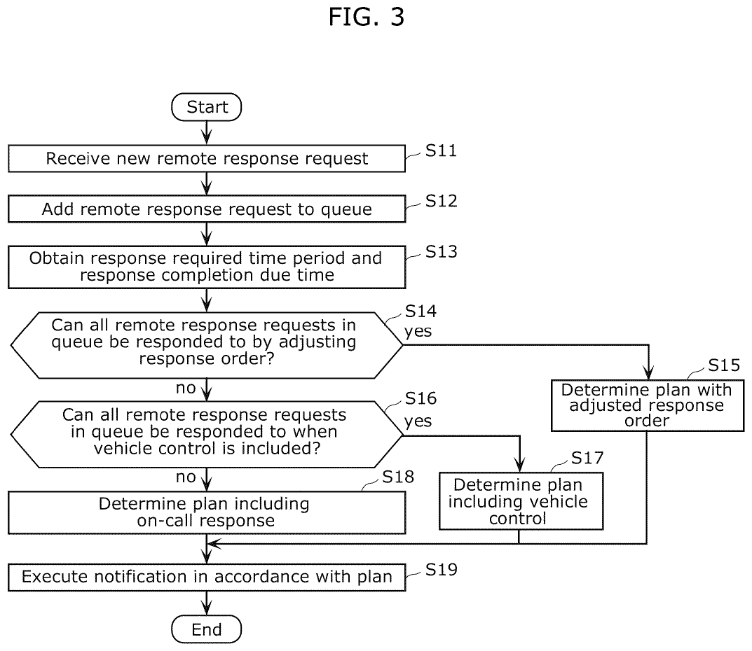

Subsequently, the operation of information processing system 1 configured as described above will be described with reference to FIGS. 3 to 8. FIG. 3 is a flowchart illustrating the operation of information processing system 1 (information processing method) according to the present embodiment. FIG. 3 illustrates the operation executed by remote control server 20.

As illustrated in FIG. 3, remote response planner 23 of remote control server 20 receives a new remote response request to one or more robots 10 from one or more of remote response requesters 12, 22, 52 (S11). Remote response planner 23 receives a new remote response request to one or more robots 10 among the plurality of robots 10 under remote control by operator U1. Note that a plurality of new remote response requests may be received simultaneously. Remote response planner 23 functions as a first obtainer.

Next, remote response planner 23 adds the received remote response request to a queue (S12). It can also be said that remote response planner 23 inputs the remote response request to the queue.

Then, remote response planner 23 obtains a response required time period and a response completion due time for each of two or more remote response requests in the queue that have not been responded to (S13). Here, not having been responded to means that a remote response request has not been subjected to a predetermined process (for example, operator U1 has not been notified of the remote response request). Remote response planner 23 obtains the response required time period and the response completion due time based on the second table in which the content of the remote response to the remote response request is associated with the response required time period and the response completion due time. Note that the response required time period may be set for each operator U1. The response completion due time may be set in accordance with the surrounding situation of robot 10 or the like.

Remote response planner 23 may obtain the response required time period and the response completion due time by performing a predetermined calculation based on the content of the remote response to the remote response request. Remote response planner 23 functions as a second obtainer.

Next, remote response planner 23 determines whether all remote response requests in the queue can be responded to by adjusting the response order (remote response order) (S14). Based on the response required time period and the response completion due time, remote response planner 23 determines whether remote responses to all remote response requests in the queue are completed by the respective response completion due times only by swapping the order in which all remote response requests in the queue are notified to operator terminal 30 of operator U1 (that is, the order in which operator U1 responds). It can also be said that remote response planner 23 determines whether a remote response order exists in which a remote response to each of two or more remote response requests in the queue can be completed by the corresponding response completion due time. Remote response planner 23 functions as a determiner.

Next, when response is determined possible in step S14 (“yes” in S14), remote response planner 23 determines a plan with an adjusted response order (S15). The plan determined in step S15 may be a plan in which the response order for each of the plurality of remote response requests has been swapped from the order of obtainment.

When response is determined not possible in step S14 (“no” in S14), remote response planner 23 determines whether response is possible for all remote response requests in the queue in a case where vehicle control is included (S16). In step S16, assuming that predetermined vehicle control is performed on one or more robots 10 among the plurality of robots 10, remote response planner 23 determines whether a remote response order exists in which a remote response to each of two or more remote response requests in the queue can be completed by the corresponding response completion due time.

Based on the response required time period and the response completion due time, remote response planner 23 determines whether remote responses to all remote response requests in the queue are completed by the response completion due times by delaying the response completion due time through vehicle control, or whether remote responses to all remaining remote response requests are completed by the response completion due times by remotely responding to a remote response request through vehicle control to reduce the number of remote response requests to be responded to by operator U1.

Next, when response is determined possible in step S16 (“yes” in S16), remote response planner 23 determines a plan including vehicle control (S17). When response is determined not possible in step S16 (“no” in S16), remote response planner 23 determines a plan including an on-call response by on-call staff member U2 (S18).

Then, controller 24 executes notification in accordance with the plan determined in step S15, S17, or S18 (S19). It can also be said that, for example, when the remote response order is determined to exist, controller 24 may execute a process for causing operator terminal 30 of operator U1 to present a notification of each of two or more remote response requests based on the remote response order. This process is an example of a predetermined process.

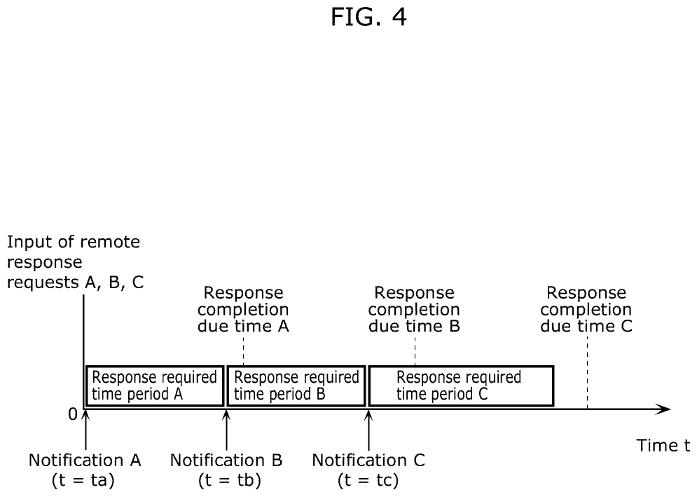

Hereinafter, a remote response order determination method for each scene will be described with reference to FIGS. 4 to 8. FIG. 4 is a diagram for describing a remote response order determination method (information processing method) when a plurality of remote responses can be completed only by remote responses from operator U1. With reference to FIG. 4, a case in which “yes” is determined in step S14 will be described. In FIGS. 4 to 8, it is assumed that, at time t =0, three remote response requests (remote response requests A, B, C) are simultaneously received, and that, at time t =0, there are no remote response requests in the queue and operator U1 is not performing a remote operation.

As illustrated in FIG. 4, remote response planner 23 receives remote response requests A, B, C at time t =0 (S11), and inputs (adds) the received remote response requests to the queue (S12). Based on the content of a remote response to each of remote response requests A, B, C and the second table, remote response planner 23 obtains respective response required time periods and respective response completion due times (S13). In the example illustrated in FIG. 4, remote response planner 23 obtains response required time period A and response completion due time A for responding to remote response request A, response required time period B and response completion due time B for responding to remote response request B, and response required time period C and response completion due time C for responding to remote response request C.

Next, remote response planner 23 determines whether a remote response order (order of notification to operator U1) of remote response requests A, B, C exists in which a remote response to remote response request A is completed by response completion due time A, a remote response to remote response request B is completed by response completion due time B, and a remote response to remote response request C is completed by response completion due time C. For example, remote response planner 23 may determine whether the remote response to remote response request A can be completed by response completion due time A based on a first time at which remote response request A can be notified and response required time period A, determine whether the remote response to remote response request B can be completed by response completion due time B based on a second time at which remote response request B can be notified and response required time period B, and determine whether the remote response to remote response request C can be completed by response completion due time C based on a third time at which remote response request C can be notified and response required time period C.

For example, when response completion due time B is later than response completion due time A and response completion due time C is later than response completion due time B, the second time may be a time that is set based on the first time and response required time period A, and the third time may be a time set based on the second time and response required time period B. The first time may be time t=0, or may be a time obtained in consideration of the processing duration of remote control server 20 with respect to time t=0. The second time may be a time at which the remote response to remote response request A is completed, and the third time may be a time at which the remote response to remote response request B is completed.

In the example illustrated in FIG. 4, remote response planner 23 determines that all remote response requests can be responded to by notifying operator U1 of remote response requests in the order of remote response to remote response requests A, B, C (“yes” in S14).

In this case, remote response planner 23 determines a plan including notifying a plurality of remote response requests in the order of remote response requests A, B, C. Specifically, remote response planner 23 determines a plan including: issuing notification A of remote response request A at time t=ta; issuing notification B of remote response request B at time t=tb; and issuing notification C of remote response request C at time t=tc (S15).

In step S19, controller 24 may issue notification A to operator terminal 30 via network N at time t =ta, thereby causing display 31 to display only notification A. Controller 24 may issue notification B to operator terminal 30 via network N at time t =tb after completing the remote response to remote response request A, thereby causing display 31 to display only notification B. Controller 24 may issue notification C to operator terminal 30 via network N at time t =tc after completing the remote response to remote response request B, thereby causing display 31 to display only notification C.

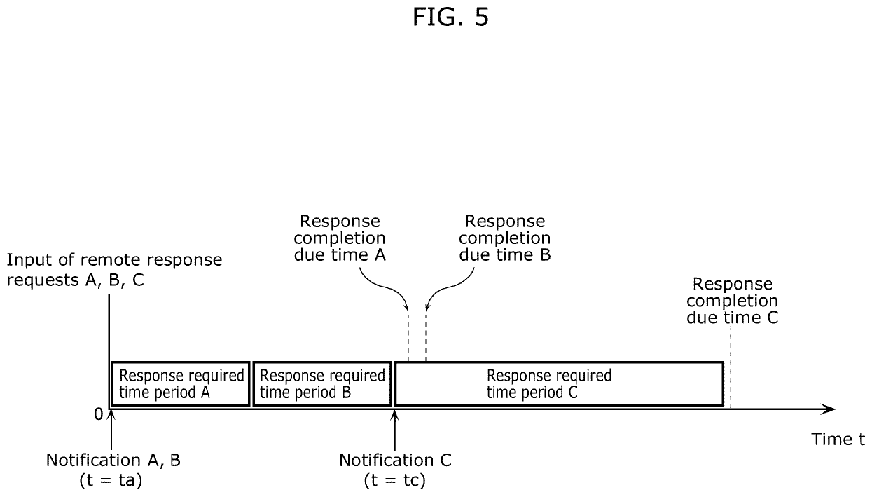

Subsequently, another example of the remote response order determination method will be described with reference to FIG. 5. FIG. 5 is a diagram for describing a remote response order determination method (information processing method) when a plurality of remote response notifications are simultaneously issued to operator U1. With reference to FIG. 5, a case in which “yes” is determined in step S14 will be described. Note that a description of content similar to that in FIG. 4 will be omitted.

As illustrated in FIG. 5, remote response planner 23 obtains response required time periods and response completion due times based on the content of the remote operation for each of remote response requests A, B, C and the second table (S13). When the remote response order is determined to exist (“yes” in S14), remote response planner 23 determines whether there are remote response requests in the remote response order that can be swapped earlier or later. For example, remote response planner 23 may determine that remote response requests A, B can be swapped earlier or later when a time based on a time at which each of remote response requests A, B can be notified and on a time period that is a sum of response required time periods A, B (in the example of FIG. 5, the time at the end of response required time period B) is earlier than each of response completion due times A, B.

The example illustrated in FIG. 5 shows a case in which obtained response completion due times A, B are later than the time when response required time periods A, B have elapsed from the current time (t=0). That is, even when the remote responses to remote response requests A, B are swapped, the remote response to remote response request A can be completed by response completion due time A, and the remote response to remote response request B can be completed by response completion due time B. In the example illustrated in FIG. 5, remote response planner 23 determines that the remote responses to remote response requests A, B can be swapped earlier or later.

In this case, remote response planner 23 determines a plan including simultaneously issuing notification A of remote response request A and notification B of remote response request B, and thereafter issuing notification C of remote response request C. Specifically, remote response planner 23 determines a plan including simultaneously issuing notifications A, B at time t=ta and issuing notification C at time t=tc.

In step S19, controller 24 issues notifications A, B simultaneously at time t=ta, thereby causing display 31 to simultaneously display notifications A, B. Controller 24 issues notification C at time t=tc after completing the remote responses corresponding to remote response requests A, B, thereby causing display 31 to display notification C.

Thus, since notifications of remote response requests A, B are simultaneously displayed, operator U1 can determine which remote response request is to be remotely responded first.

When controller 24 causes display 31 to simultaneously display notifications A, B, controller 24 may cause information indicating respective response priorities for notifications A, B to be displayed in combination. The response priorities are information for assisting operator U1 in determining which of notifications A, B is to be responded to first, and includes information indicating which of notifications A, B is to be responded to preferentially by operator U1. Each response priority may be predetermined in accordance with the category of the remote response request, or may be calculated based on the response completion due time. For example, the response priority may be calculated such that the shorter the response completion due time, the higher the response priority.

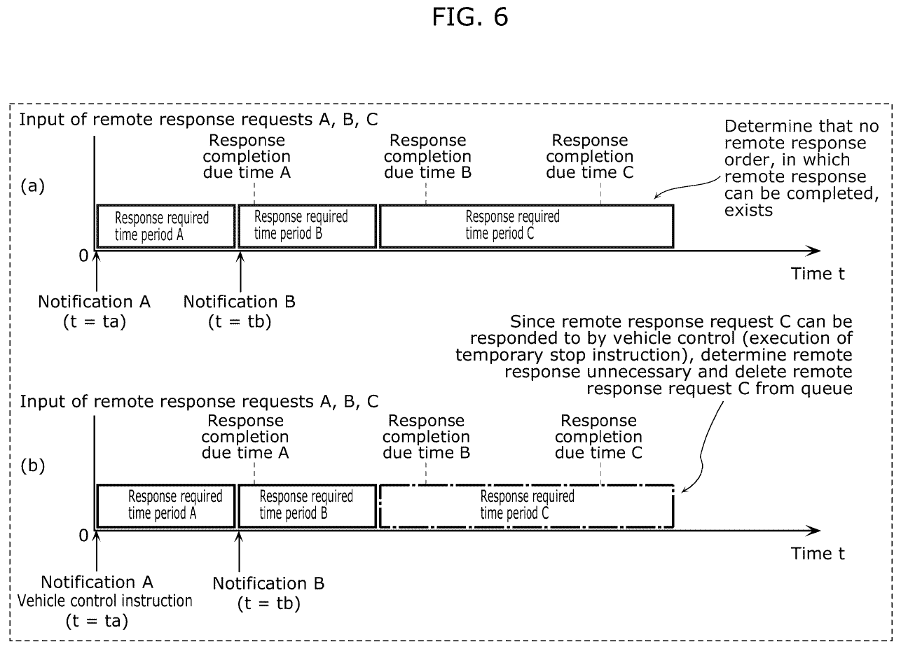

Subsequently, another example of the remote response order determination method will be described with reference to FIG. 6. FIG. 6 is a diagram for describing an example of the remote response order determination method (information processing method) when vehicle control is performed. (a) of FIG. 6 illustrates the remote response order before vehicle control is performed, and (b) of FIG. 6 illustrates the remote response order after vehicle control has been performed. With reference to FIG. 6, a case will be described in which some of the remote response requests are deleted from the queue by performing vehicle control, and “yes” is determined in step S16. Note that a description of content similar to that in FIG. 4 will be omitted.

In the case illustrated in (a) of FIG. 6, since the remote response to remote response request C is not completed by response completion due time C, remote response planner 23 determines that all remote response requests in the queue cannot be responded to even by adjusting the remote response order, that is, no remote response order exists in which all remote responses can be completed only by adjusting the remote response order (“no” in S14).

Next, remote response planner 23 determines whether it is possible to make a plan including vehicle control (S16). For example, remote response planner 23 extracts, from the remote control information, remote response requests that can be subjected to vehicle control from among remote response requests A to C. It is assumed that, for example, remote response planner 23 obtains, from the remote control information, information indicating that remote response request C can be made unnecessary by vehicle control (for example, execution of a temporary stop instruction).

In this case, remote response planner 23 determines that robot 10 corresponding to remote response request C can be subjected to vehicle control of a temporary stop and that remote response is made unnecessary by temporarily stopping the robot by vehicle control, and deletes remote response request C from the queue. In other words, remote response request C is excluded from the remote response requests on which the predetermined process is to be executed. This results in only remote response requests A, B being included in the queue.

Based on the response required time period and the response completion due time for the remote response request for each of one or more other robots 10 among the plurality of robots 10 except for one or more robots 10 to be subjected to vehicle control, remote response planner 23 determines whether a remote response order exists in which the remote response to the remote response request for each of one or more other robots 10 can be completed by the corresponding response completion due time.

As illustrated in (b) of FIG. 6, remote response planner 23 determines that all remote response requests except for deleted remote response request C can be responded to by notifying operator U1 of remote response requests in the order of remote response to remote response requests A, B (“yes” in S16). Note that (b) of FIG. 6 illustrates, by enclosing response required time period C with a dash-dotted line, that remote response request C is excluded.

Remote response planner 23 determines a plan including: notifying a plurality of remote response requests in the order of remote response requests A, B; and issuing a vehicle control instruction (here, a temporary stop instruction) for executing vehicle control on robot 10 corresponding to remote response request C. Specifically, remote response planner 23 determines a plan including: issuing notification A of remote response request A and a vehicle control instruction to robot 10 corresponding to remote response request C at time t=ta; and issuing notification B of remote response request B at time t=tb (S17).

Thus, in step S19, controller 24 issues notification A and a vehicle control instruction simultaneously at time t=ta, thereby causing display 31 to display notification A and executing vehicle control on robot 10 corresponding to remote response request C. Controller 24 issues notification B at time t =tb after completing the remote response to remote response request A, thereby causing display 31 to display notification B. Note that the vehicle control instruction is not limited to being issued at time t=ta.

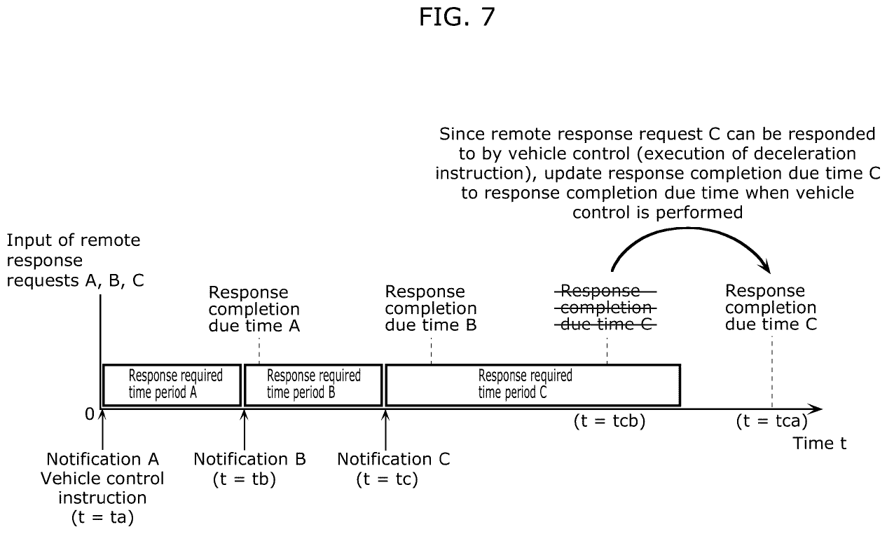

Subsequently, another example of the remote response order determination method will be described with reference to FIG. 7. FIG. 7 is a diagram for describing another example of the remote response order determination method (information processing method) when vehicle control is performed. With reference to FIG. 7, a case will be described in which a response completion due time for a remote response request is delayed by performing vehicle control, whereby “yes” is determined in step S16. Note that the remote response order before vehicle control is performed is assumed to be the same as that in (a) of FIG. 6. Hereinafter, a description will be given of a process after determination is made that no remote response order exists in which all remote responses can be completed based only on the remote response order (“no” in S14).

Each of remote response requests A, B is a request from robot 10 being stopped, and is, for example, a safety confirmation request for starting travel. In this case, the remote response of operator U1 is exemplified by a travel start instruction. Remote response request C is a request from robot 10 that is traveling, and is, for example, a request for notifying that robot 10 will pass by a pedestrian on a narrow road. In this case, the remote response of operator U1 is exemplified by a temporary stop instruction.

Remote response planner 23 determines whether it is possible to make a plan including vehicle control (S16). For example, remote response planner 23 obtains, from the remote control information, vehicle control information including vehicle control candidates corresponding to the remote response requests and the priority of execution of vehicle control for each vehicle control candidate, and makes the determination in step S16 based on the obtained vehicle control information.

Here, vehicle control information is assumed to be obtained, which includes that there are no vehicle control candidates corresponding to remote response requests A, B, and that there is a vehicle control candidate of a temporary stop or deceleration corresponding to remote response request C. The fact that there are no vehicle control candidates corresponding to remote response requests A, B is based on a determination that, for example, there is a high risk in automatically issuing a travel resumption instruction. The execution priority is assumed to be “low” for a temporary stop and “high” for a deceleration. This execution priority is based on a determination that, for example, the risk of stopping the vehicle is higher.

Remote response planner 23 determines, in descending order of execution priority of vehicle control candidates, whether all remote responses can be completed by the response completion due times when vehicle control is performed. When the vehicle control information is obtained, remote response planner 23 determines whether all remote response requests can be responded to by the response completion due times when a deceleration with a higher execution priority is performed on remote response request C. When response is determined possible, remote response planner 23 determines to execute a deceleration as the vehicle control. When response is determined not possible, remote response planner 23 determines whether all remote response requests can be responded to by the response completion due times when a temporary stop with a lower execution priority is performed on remote response request C. When response is determined possible, remote response planner 23 determines to execute a temporary stop as the vehicle control, and when response is determined not possible, remote response planner 23 proceeds to step S18.

FIG. 7 illustrates an example in which a deceleration is executed as the vehicle control. When a deceleration is executed as the vehicle control on robot 10 corresponding to remote response request C, remote response planner 23 further obtains, based on the vehicle control information, a response completion due time (time t=tca) for robot 10 that is later than the time when no deceleration is performed. Based on the obtained response completion due time for robot 10, remote response planner 23 determines whether a remote response order exists. For example, remote response planner 23 determines that the response completion due time can be delayed from time t=tcb to time t=tca. Time t=tcb is the time when the predetermined vehicle control is not executed, and time t=tca is the time when the predetermined vehicle control is executed.

Note that FIG. 7 illustrates, by drawing a strikethrough line on response completion due time C at time t=tcb, that response completion due time C is delayed.

Remote response planner 23 then makes the determination in step S16 based on which is later, the end time of response required time period C or time t=tca. When the end time of response required time period C is later, remote response planner 23 determines “no” in step S16, and when time t=tca is later, remote response planner 23 determines “yes” in step S16. FIG. 7 illustrates the case where time t=tca is later.

Remote response planner 23 determines a plan including: notifying remote response requests to be responded to in the order of remote response requests A, B, C; and issuing a vehicle control instruction (in this case, a deceleration instruction) for executing vehicle control on robot 10 corresponding to remote response request C. Specifically, remote response planner 23 determines a plan including: issuing notification A of remote response request A and a vehicle control instruction to robot 10 corresponding to remote response request C at time t=ta; issuing notification B of remote response request B at time t=tb; and issuing notification C of remote response request C at time t=tc (S17).

In step S19, controller 24 simultaneously executes notification A and the vehicle control instruction at time t=ta, executes notification B after completing the remote response to remote response request A, and executes notification C after completing the remote response to remote response request B. Note that the vehicle control instruction is not limited to being issued at time t=ta.

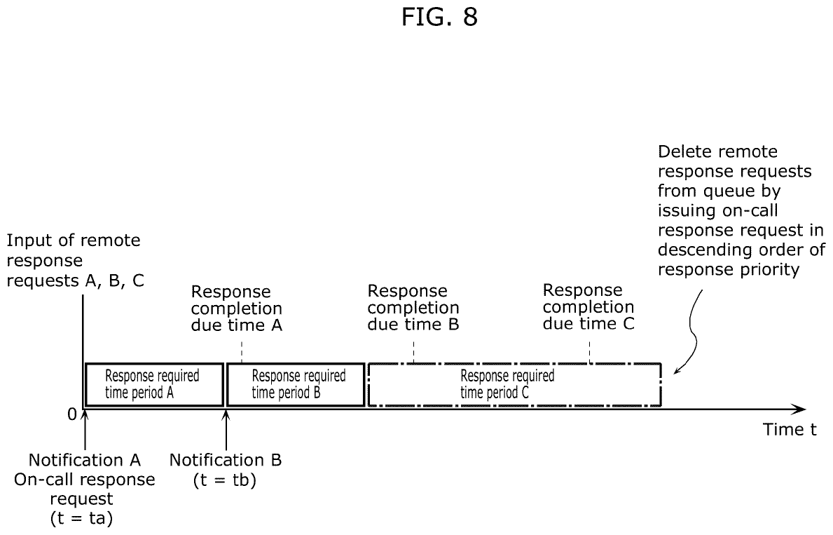

Subsequently, another example of the remote response order determination method will be described with reference to FIG. 8. FIG. 8 is a diagram for describing a remote response order determination method (information processing method) when an on-call response request is issued. With reference to FIG. 8, a case will be described in which some of the remote response requests are deleted from the queue by issuing an on-call response request, and the plan of step S18 is determined. Note that the response order before the on-call response request is issued is assumed to be the same as that in (a) of FIG. 6. Hereinafter, a description will be given of a process after determination is made that no remote response order exists in which all remote responses can be completed even when vehicle control is included (“no” in S16).

Each of remote response requests A, B is a request from robot 10 being stopped, and is, for example, a safety confirmation request for starting travel. In this case, the remote response of operator U1 is exemplified by a travel start instruction. Remote response request C is a request from robot 10 that is a vehicle parked on the road and is stuck. In this case, the remote response of operator U1 is exemplified by a remote operation (remote control).

When “no” is determined in step S16, remote response planner 23 determines a plan in which all remote response requests can be responded to by the response completion due times through inclusion of an on-call response. Remote response planner 23 obtains the respective response priorities for remote response requests A to C from the remote control information, for example.

It is assumed here that information is obtained from the remote control information, including that the response priority is “low” for each of remote response requests A, B, and “high” for remote response request C. That the response priority is “low” for each of remote response requests A, B is based on a determination, for example, that there is a high risk in automatically issuing a travel resumption instruction. On the other hand, that the response priority is “high” for remote response request C is based on a determination, for example, that there is a high possibility of disturbing other traffic.

Remote response planner 23 deletes remote response requests from the queue by issuing an on-call response request in descending order of response priority until all remote response requests can be responded to by the response completion due times. For example, remote response planner 23 determines whether all remaining remote response requests can be responded to by the response completion due times on every switching to an on-call response request.

In this case, remote response planner 23 determines that remote response is made unnecessary by issuing an on-call response request to robot 10 corresponding to remote response request C, and deletes the remote response request from the queue. The example illustrated in FIG. 8 shows a case in which remote response request C is deleted from the queue by being switched to an on-call response request, and the queue includes only remote response requests A, B. As illustrated in FIG. 8, remote response planner 23 determines that all remote response requests except for deleted remote response request C can be responded to by notifying operator U1 of remote response requests in the order of response to remote response requests A, B.

Remote response planner 23 determines a plan including: notifying remote response requests to be responded to in the order of remote response requests A, B; and issuing an on-call response request to cause robot 10 corresponding to remote response request C to promptly proceed. Specifically, remote response planner 23 determines a plan including: issuing notification A of remote response request A and an on-call response request to staff member terminal 40 at time t=ta; and issuing notification B of remote response request B at time t=tb (S18).

In step S19, controller 24 simultaneously executes notification A and the on-call response request at time t=ta, and executes notification B at time t=tb after completing the remote response to remote response request A. Controller 24 transmits the on-call response request to staff member terminal 40 via network N at time t=ta. In this manner, assuming that predetermined vehicle control is performed on one or more robots 10, when determination is made that no remote response order exists, remote response planner 23 transmits, as the predetermined process, to staff member terminal 40 of the on-call staff member, a notification requesting an on-call response. Note that the on-call response request is not limited to being issued at time t=ta.

In each of FIGS. 4 to 8, an example has been described in which the remote response order is determined such that the next remote response is immediately started at a certain remote response end time. However, the present disclosure is not limited thereto, and for example, a remote response order may be determined in which a predetermined margin (temporal margin) is provided between a certain remote response end time and the next remote response start time. Referring to FIG. 4 as an example, remote response planner 23 may include a temporal margin of a predetermined length in at least one of the following: between response required time period A of remote response request A and response required time period B of remote response request B executed after remote response request A; or between response required time period B of remote response request B and response required time period C of remote response request C executed after remote response request B. Remote response planner 23 determines whether a remote response order including such a temporal margin of a predetermined length exists. When the existence is determined, remote response planner 23 may employ a remote response order including the temporal margin of a predetermined length.

This makes it possible to reduce occurrences in which an actually performed remote response exceeds an estimated response required time period, thereby preventing the response to the remote response request or another remote response request (subsequent remote response request) from being completed by the response completion due time. It is also possible to reduce a psychological burden on operator U1, which increases when the remote response is consecutively performed. Note that the temporal margin of a predetermined length may be, for example, a uniform time period, may be set in accordance with the content of the remote response, or may be set in accordance with the performance, skills, or the like of operator U1.

### Variation of Embodiment

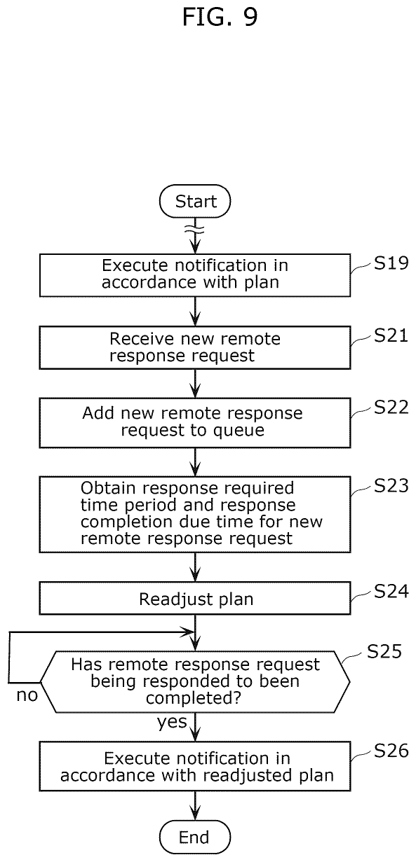

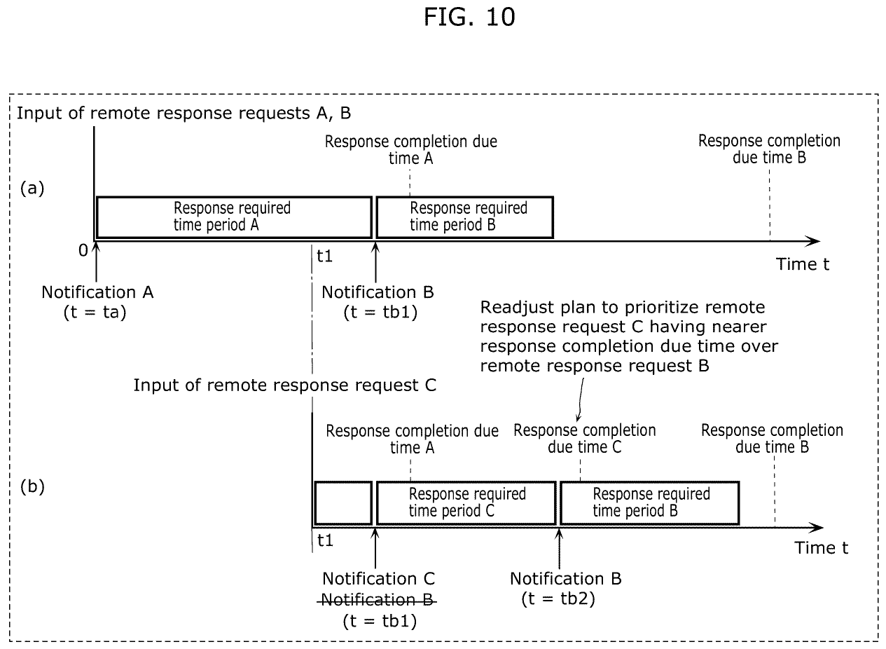

Hereinafter, an information processing system according to the present variation will be described with reference to FIGS. 9 and 10. In the following, differences from the embodiment will be mainly described, and a description of the same or similar content to that in the embodiment will be omitted or simplified. The configuration of the information processing system according to the present variation may be similar to that of information processing system 1 according to the embodiment, and a description thereof will be omitted. In addition, reference numerals of information processing system 1 according to the embodiment will be used below.

FIG. 9 is a flowchart illustrating the operation of information processing system 1 (information processing method) according to the present variation. FIG. 10 is a diagram for describing a method of determining a readjusted remote response order (information processing method).

In FIG. 9, the processes of steps S11 to S18 illustrated in FIG. 3 are omitted. For example, after execution of steps S11 to S19 illustrated in FIG. 3, the process of step S21 illustrated in FIG. 9 is executed.

As illustrated in FIG. 9, after execution of notification in accordance with the plan determined in step S15, S17, or S18 (see (a) of FIG. 10), for example, while operator U1 is performing remote response, remote response planner 23 of remote control server 20 receives a new remote response request (S21) and adds the new remote response request to the queue (S22). It can also be said that remote response planner 23 inputs the new remote response request to the queue. FIG. 10 illustrates an example in which remote response request C is received and added to the queue at time t=t1 when operator U1 is remotely responding to remote response request A.

Next, remote response planner 23 obtains a response required time period and a response completion due time for the new remote response request (S23). Step S23 is a process similar to step S13, and a description thereof is omitted.

Then, remote response planner 23 readjusts the plan based on the response required time period and the response completion due time of one or more remote response requests included in the queue (including the response required time period and the response completion due time obtained in step S23), excluding the remote response request currently being responded to by operator U1 (S24). Remote response planner 23 determines a plan with an adjusted response order (corresponding to S15) when response is possible by adjusting the response order (corresponding to “yes” in S14), determines a plan including vehicle control (corresponding to S17) when response is possible in the case of vehicle control being included (corresponding to “yes” in S16), and determines a plan including an on-call response (corresponding to S18) when response is not possible even in the case of vehicle control being included (corresponding to “no” in S16).

FIG. 10 illustrates an example in which response completion due time C obtained in step S23 is a time between the response completion due times A, B, and response completion due time C cannot be achieved when the remote response to remote response request C is planned after the remote response to remote response request B in step (a) of FIG. 10, so that the order of remote response requests B, C is swapped as illustrated in step (b) of FIG. 10. Remote response planner 23 determines that all remote responses can be completed by the response completion due times by updating the plan to enable the order of remote response requests B, C to be swapped (corresponding to “yes” in step S16). Remote response planner 23 updates the remote response order based on response required time period B, response completion due time B, response required time period C, and response completion due time C.

Remote response planner 23 determines a plan including notifying remote response request A, and thereafter notifying remote response requests C, B in this order. Specifically, remote response planner 23 determines a plan including: issuing notification C of remote response request C at time t=tb1; and issuing notification B of remote response request B at time t=tb2 instead of time t=tb1. Note that FIG. 10 illustrates, by drawing a strikethrough line on notification B at time t=tb1, that notification B is delayed.

Next, controller 24 determines whether the remote response request being responded to has been completed (S25). In the example of FIG. 10, controller 24 determines whether remote response request A has been completed. Controller 24 may accept, for example, an operation from operator U1 indicating that remote response request A has been completed.

When controller 24 determines that the remote response request being responded to has been completed (“yes” in S25), controller 24 executes notification in accordance with the readjusted plan (S26). Controller 24 executes notification C at time t=tb1 after completing remote response request A, and executes notification B at time t=tb2 after completing the remote response to remote response request A. When controller 24 determines that the remote response request being responded to has not been completed (“no” in S25), controller 24 returns to step S25 and waits until completion.

In this manner, the plan is readjusted when a new remote response request is received while operator U1 is responding to a remote response request, so that the responses to all remote response requests in the queue including the new remote response request can be completed by the response completion due times.

### Display Examples to Operator

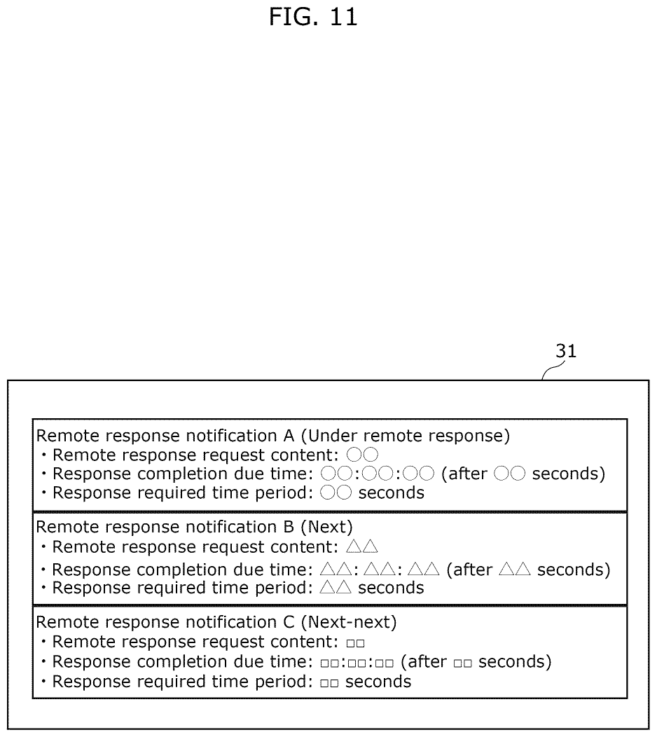

Hereinafter, a variety of display examples of operator terminal 30 in information processing system 1 according to the embodiment and the variation of the embodiment will be described with reference to FIGS. 11 to 13. In the following, the embodiment and the variation of the embodiment will also be referred to as the embodiment and the like.

First, a display example of information displayed on operator terminal 30 in response to notification in step S19 will be described with reference to FIG. 11. FIG. 11 is a first diagram illustrating a display example of operator terminal 30 (display 31) according to the present embodiment and the like. FIG. 11 illustrates a remote response notification when the remote operation order illustrated in FIG. 4 is determined. Although FIG. 11 illustrates an example in which remote response notification A corresponding to remote response request A, remote response notification B corresponding to remote response request B, and remote response notification C corresponding to remote response request C are displayed side by side on one screen, it is sufficient that at least remote response notification A, which is currently being responded to, is displayed. The remote response notification is a notification for a remote response request that requires a remote response.

As illustrated in FIG. 11, controller 24 may cause operator terminal 30 to display, for example, the response required time period corresponding to the remote response notification (for example, the response required time period corresponding to remote response notification A currently being responded to). This enables operator U1 to understand the response required time period assumed by remote control server 20 and thereby use the response required time period as a guide for the time period required for remote response. Controller 24 causes operator terminal 30 to display, together with the above, for example, the response completion due time corresponding to the remote response notification (for example, the response completion due time corresponding to remote response notification A currently being responded to). This enables operator U1 to understand the time by which the remote response is to be completed so as not to impede completion of the entire remote response.

Controller 24 may cause operator terminal 30 to display at least one of a response required time period for each remote response notification (for example, the response required time period corresponding to each of remote response notifications A to C) or a response completion due time for each remote response notification (for example, the response completion due time corresponding to each of remote response notifications A to C). This enables operator U1 to grasp a sense of the future schedule and thereby reduce the psychological burden on operator U1, such as a feeling of needing to respond in unnecessary haste.

For example, when the response completion due time is approaching during execution of the remote response, controller 24 may cause operator terminal 30 to display that the remaining time period until the response completion due time (hereinafter referred to as “due time period”) is decreasing. This makes it possible to reduce the amount of information required for operator U1 to understand the time by which the remote response is to be completed so as not to impede completion of the entire remote response.

Note that controller 24 may cause operator terminal 30 to display at least one of the response required time period, the response completion due time, or that the due time period is decreasing (for example, “after ○○ seconds” in FIG. 11).

As illustrated in FIG. 11, controller 24 may cause operator terminal 30 to display the remote response notification before the remote response notification time determined in accordance with the remote response order determined by remote control server 20. For example, controller 24 may cause operator terminal 30 to display, in addition to the most recent remote response notification, the remote response notification scheduled for the next time or later. As a result, operator U1 can understand in advance the remote response scheduled to be performed later, thereby reducing the time period required to understand the content of the remote response at the time of performing the next remote response.

Controller 24 may cause operator terminal 30 to only display the presence or absence of remote response notifications or the number of remote response notifications. This reduces the amount of information to be understood by operator U1, thereby enabling operator U1 to readily grasp a sense of the future schedule while reducing the burden on operator U1.

When the presence or absence of remote response notifications or the number of remote response notifications is displayed, controller 24 may cause operator terminal 30 to further display the content through a detailed information display operation. For example, when controller 24 causes operator terminal 30 to display the presence of remote response notification A and accepts a detailed information display operation via operator terminal 30, controller 24 may cause at least one of the following items to be displayed: the content of the remote response request, the response completion due time, the response required time period, the response completion due time, or that the due time period is decreasing. This makes it possible to switch the amount of information to an appropriate level in accordance with operator U1's preference. Note that the detailed information display operation is an operation for displaying detailed information executed by operator U1. The detailed information display operation may be, for example, operator U1 clicking an icon for displaying detailed information or making an utterance indicating that the detailed information is to be displayed.

When the remote response order is updated as described above, controller 24 may notify operator terminal 30 of the update. Controller 24 may, for example, issue a notification to highlight the updated portion. This enables operator U1 to readily become aware that the previously grasped sense of the future schedule has been changed, and also enables operator U1 to change the content of the preliminary preparation. For example, only when the remote response order is updated for the next response following the response currently being performed, controller 24 may issue a notification of the update. Controller 24 does not need to issue a notification when a remote response order beyond the next is updated, because operator U1, even when preparing, almost always prepares for the next response in the remote response order. Controller 24 may automatically switch to the next remote response request response screen in accordance with the remote response order at each completion of a response to a remote response request.

Controller 24 may cause additional information about the most recent task to be displayed. An example of the additional information is the response completion due time period for the most recent task. This enables operator U1 to know how long a remaining time period is required to perform the currently executing task while executing the task. Note that the additional information is not limited to the response completion due time period. Controller 24 may cause the presence or absence of a task after the most recent task to be displayed as additional information. This enables operator U1 to know whether there is a task to be executed after the currently executing task and thereby prepare for the next task before completing the currently executing task. Controller 24 may cause an alert notification to be displayed as additional information when the deadline for the response completion due time period for the most recent task is approaching. This enables the notification to be limited to a minimum, only when the deadline for the response due time is approaching, thereby reducing the amount of information displayed.

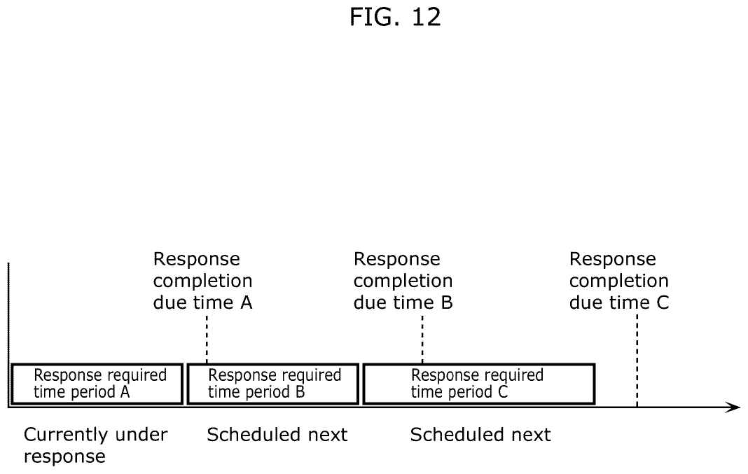

FIG. 12 is a second diagram illustrating a display example of operator terminal 30 (display 31) according to the present embodiment and the like. FIG. 12 illustrates an example in which the entire task schedule is displayed when the response order illustrated in FIG. 4 is determined.

As illustrated in FIG. 12, after the remote response order is determined, controller 24 may cause operator terminal 30 to display the entire task schedule to enable operator U1 to understand in what order the tasks are to be performed. The example illustrated in FIG. 12 shows the task currently being responded to (the task corresponding to response required time period A in FIG. 12) and the next scheduled tasks (the tasks corresponding to the response required time periods B, C in FIG. 12). Thus, operator U1 can intuitively understand that the task corresponding to response required time period B and the task corresponding to response required time period C need to be performed in this order after the current task and can thereby prepare in advance for the next remote response request.

Controller 24 may cause operator terminal 30 to display the entire task schedule. This enables operator U1 to know whether there is a remote response request that needs to be responded to after the response to the remote response request currently being responded to. Therefore, when there is a remote response request that needs to be responded to after the response to the remote response request currently being responded to, operator U1 can be made aware to complete the remote response request currently being responded to as soon as possible. For example, it is possible to prevent operator U1 from slowly responding to the request and the expected response required time period from being exceeded because it is not known whether there is a remote response request that needs to be responded to after the response to the remote response request currently being responded to. Note that controller 24 does not need to cause the entire schedule to be displayed. For example, controller 24 may cause one or more of the following to be displayed: information on the presence or absence of a remote response request that needs to be responded to after the response to the remote response request currently being responded to, and a schedule for some of the remote response requests that need to be responded to. Thus, while obtaining the above effects, it is possible to reduce the burden on operator U1 in understanding the entire task.

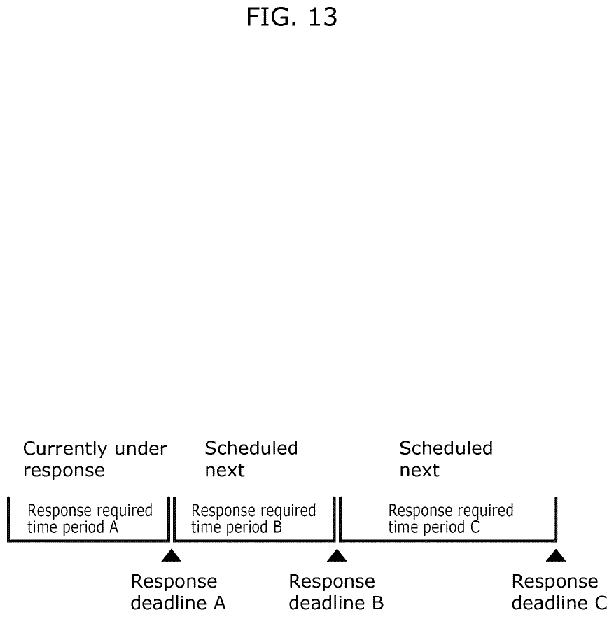

FIG. 13 is a third diagram illustrating a display example of operator terminal 30 (display 31) according to the present embodiment and the like. FIG. 13 illustrates another example in which the entire task schedule is displayed when the response order illustrated in FIG. 4 is determined.

As illustrated in FIG. 13, controller 24 does not need to display the response completion due time because, if the response completion due time is displayed and there is a sufficient margin until the response completion due time, operator U1 may respond slowly. On the other hand, controller 24 may cause the response required time periods, which were used for planning the remote response order (response required time periods A to C illustrated in FIG. 13), to be displayed. This enables operator U1 to know that remote responses may be performed using the response required time periods, which were used for planning the remote response order, as guides for the response deadlines (response deadlines A to C illustrated in FIG. 13).

Note that the response completion due time may be confirmable, although not displayed. For example, controller 24 may cause the response completion due time to be displayed when accepting the detailed information display operation by operator U1. In addition, the display illustrated in FIG. 13 may be automatically switched to the next remote response screen in accordance with a schedule at each completion of a response to one task.

In each of FIGS. 11 to 13, an example has been described in which information related to remote response is displayed on operator terminal 30, but other information may also be displayed on operator terminal 30 together with the information related to remote response. For example, controller 24 may cause operator terminal 30 to display, together with the information related to remote response, the state of a vehicle that is currently subjected to remote control or that needs to be remotely responded to next. Controller 24 may cause the information related to remote response and the state of the vehicle to be displayed side by side on one screen. The state of the vehicle may be, for example, information indicating a travel state such as the position, speed, or the like of the vehicle, or information indicating a peripheral state of the vehicle such as an image captured by an imaging device mounted on the vehicle or a detection result of a sensor.

This makes it possible to reduce the time period required for operator U1 to understand the state of the vehicle before performing remote response.

### Other Embodiments

Although the present disclosure has been described above based on the embodiment and the variation of the embodiment, the present disclosure is not limited to the above embodiment and the like. Unless deviating from the gist of the present disclosure, the present disclosure may include a form of the present embodiment with various modifications applied or a form constructed by combining components of different embodiments.

For example, remote response planner 23 in the above embodiment and the like may calculate the response required time period using at least one of the skill level or the fatigue level of operator U1. For example, remote response planner 23 may extend the response required time period obtained in step S13 when determining that the skill level of operator U1 is greater than or equal to a predetermined value or that the fatigue level of operator U1 is less than a predetermined value. Remote response planner 23 may shorten the response required time period obtained in step S13 when determining that the skill level of operator U1 is less than a predetermined value or that the fatigue level of operator U1 is greater than or equal to a predetermined value. Remote response planner 23 may calculate the response required time period using at least one of the road conditions or the surrounding situation of robot 10. For example, remote response planner 23 may extend the response required time period obtained in step S13 when determining that the surroundings of robot 10 are crowded based on at least one of the road context or the surrounding situation of robot 10. Remote response planner 23 may shorten the response required time period obtained in step S13 when determining that the surroundings of robot 10 are not crowded based on at least one of the road context or the surrounding situation of robot 10. In this manner, for example, remote response planner 23 may correct the response required time period obtained in step S13 based on at least one of the skill level or fatigue level of operator U1, the road context, or the surrounding situation of robot 10. As a result, the response required time period can be calculated more accurately, so that remote response planner 23 can determine a plan with higher accuracy.

Remote response planner 23 in the above embodiment and the like may calculate the response completion due time based on at least one of the road context or the surrounding situation of robot 10. For example, remote response planner 23 may shorten the response completion due time obtained in step S13 when determining that the number of people around robot 10 is high based on at least one of the road context or the surrounding situation of robot 10. Remote response planner 23 may extend the response completion due time obtained in step S13 when determining that the number of people around robot 10 is low based on at least one of the road context or the surrounding situation of robot 10. Remote response planner 23 may calculate the response completion due time using at least one of a travelable time period or a scheduled travel route of robot 10. Remote response planner 23 may extend the response completion due time obtained in step S13 when determining that the travelable time period is greater than or equal to a predetermined value or that the scheduled travel distance based on the scheduled travel route is less than a predetermined value. Remote response planner 23 may shorten the response completion due time obtained in step S13 when determining that the travelable time period is less than a predetermined value or that the scheduled travel distance based on the scheduled travel route is greater than or equal to a predetermined value. As described above, remote response planner 23 may correct the response completion due time obtained in step S13 based on at least one of the road context, the surrounding situation of robot 10, or the travelable time period and the scheduled travel route of robot 10. As a result, the response completion due time can be calculated more accurately, so that remote response planner 23 can determine a plan with higher accuracy. Note that the travelable time period of robot 10 can be calculated from, for example, the remaining battery power, the remaining fuel level, or the like of robot 10, and the scheduled travel route can be obtained from information indicating a travel route.

Remote response planner 23 in the above embodiment and the like may cause display 31 to simultaneously display a plurality of notifications at the timing for notification of the remote response request. This enables operator U1 to determine the remote response order. Note that the number of notifications to be displayed simultaneously may be changed in accordance with at least one of the skill level or the fatigue level of operator U1.

Remote response planner 23 in the above embodiment and the like may update at least one of the response required time period or the response completion due time for the remote response request stored in the queue, based on the status of robot 10 requiring remote response, or the like. The update may be executed periodically, for example. Remote response planner 23 may readjust the plan based on at least one of the updated response required time period or the response completion due time. Thus, re-planning can be performed when the operation status changes, thereby improving the accuracy of the plan.

When there are a plurality of operators U1, remote response planner 23 in the above embodiment and the like may determine operator terminal 30 to be notified in accordance with at least one of the skill level or the fatigue level of operator U1. For example, remote response planner 23 may preferentially notify operator terminal 30 of operator U1 having a high skill level or a low fatigue level.

Remote response planner 23 in the above embodiment and the like may be configured to respond to one remote response request by combining remote response, vehicle control, and on-call response. Thus, by vehicle control, a plan having a shorter response required time period and a shorter response completion due time for the remote response request can be generated.

When a response completion prediction time does not have a sufficient margin with respect to the response completion due time (for example, less than a predetermined time period) although response is possible based only on the order of notification of remote response requests, remote response planner 23 in the above embodiment and the like may be configured to issue at least one of a vehicle control instruction or an on-call response request for extending the response completion due time or deleting the remote response request from the queue. This makes it possible to prevent operation failure even when the actual remote response exceeds the response required time period determined at the planning stage.

When the response completion prediction time does not have a sufficient margin with respect to the response completion due time although response is possible based on the order of notification of remote response requests and vehicle control, remote response planner 23 in the above embodiment and the like may be configured to issue an on-call response request for extending the response completion due time or deleting the remote response request from the queue. This makes it possible to prevent operation failure even when the actual remote response exceeds the response required time period determined at the planning stage.

When a plurality of remote response requests as illustrated in FIG. 5 can be simultaneously notified to operator terminal 30 of operator U1, remote response planner 23 in the above embodiment and the like may be configured to preferentially transmit the most effective candidate (remote response request) to operator terminal 30 based on information related to service quality such as delay in arrival time at a delivery point. Remote response planner 23 may plan to preferentially notify operator terminal 30 of operator U1 of one of remote response requests A, B that has a greater decrease in service quality (for example, greater arrival delay). Remote response planner 23 may be configured to preferentially select robot 10 that has completed a service, such as a return in a delivery service, as a candidate for vehicle control. Remote response planner 23 may, for example, calculate the arrival delay time period when vehicle control is performed on each vehicle control candidate, and determine to perform the vehicle control that results in the minimum arrival delay time period. This makes it possible to prevent operation failure while minimizing deterioration in service quality.

When performing a remote response to each of a plurality of robots 10, remote response planner 23 in the above embodiment and the like may be configured to select the most effective candidate (remote response request) based on information related to service quality such as delay in arrival time at the delivery point, or may be configured to preferentially issue a vehicle control instruction or an on-call response request to robot 10 that has completed a service such as a return in the delivery service. Remote response planner 23 may, for example, calculate the arrival delay time period of each candidate and select robot 10 to which at least one of a vehicle control instruction or an on-call response request to be issued, such that the total of the arrival delay time periods is minimized. Remote response planner 23 may, for example, obtain priorities based on information related to service quality (for example, delay time period) for a plurality of remote response requests, as illustrated in remote response requests A, B in FIG. 5, and determine which one is to be notified to operator terminal 30 of operator U1 first based on the obtained priorities. For example, when there are two or more remote response requests with equal priorities, remote response planner 23 may determine to preferentially notify operator terminal 30 of operator U1 of the remote response request corresponding to robot 10 making delivery, between robot 10 making delivery and robot 10 after delivery. This makes it possible to prevent operation failure while minimizing deterioration in service quality.

When there is only one remote response request in the queue, remote response planner 23 in the above embodiment and the like may determine the timing for notification based on the status of operator U1. When operator U1 is currently performing remote response, remote response planner 23 may determine, after completion of the remote response, to notify operator terminal 30 of operator U1 of the remote response request accumulated in the queue. When operator U1 is not currently performing remote response, remote response planner 23 may determine to immediately notify operator terminal 30 of operator U1 of the remote response request accumulated in the queue.

Remote response planner 23 in the above embodiment and the like may be configured to preferentially notify a remote response request for which the response required time period is less than a predetermined value when the response required time period varies. For example, in a situation where remote response is executed such that a departure operation is performed after the amount of traffic around the vehicle decreases, remote response planner 23 may calculate the response required time period based on the amount of traffic around the vehicle detected by a sensor or the like, and may preferentially notify a remote response request for a vehicle for which the calculated response required time period is less than a predetermined value over remote response requests for other vehicles. For example, in a case where the amount of traffic is small or other cases, the response required time period may be less than a predetermined value. The predetermined value may be preset and stored in storage 21. The predetermined value may be a uniform value, may be individually set in accordance with the content of the remote response, or may be calculated based on the response completion due time and the response required time period of the next remote response. Thus, by preferentially completing the remote response for the vehicle at the timing when the response required time period is small, it is possible to reduce the occurrence of cases in which the remote response cannot be completed by the response completion due time for another remote response.

In the above embodiment and the like, an example has been described in which remote response requests A, B are obtained simultaneously. However, remote response requests A, B may be obtained at different times, for example, consecutively. For example, when remote response request A is obtained before remote response request B, and determination is made that a remote response order exists, remote response planner 23 may determine a plan for executing a predetermined process in the order of remote response requests A, B, or a plan for executing a predetermined process in the order of remote response requests B, A, such that the respective remote responses can be completed by the response completion due time. Remote response planner 23 may determine a plan for executing the predetermined process in the order of obtainment of the remote response requests, or may determine a plan for executing the predetermined process in an order different from the order of obtainment.

In the above embodiment and the like, an example has been described in which the remote response request is to request an operator remotely located from the mobile body to remotely perform a response related to the movement of the mobile body. However, the present disclosure is not limited thereto, and the remote response request may be a remote response request estimated to occur at a future time by estimating the future state of the vehicle based on past travel data, vehicle sensor information, or the like. Thus, when a new remote response request is input after determination of the remote response order, it is possible to reduce the occurrence of cases in which the remote response order including the new remote response request cannot be determined.

In the above embodiment and the like and the like, an example has been described in which the remote response request is obtained from a mobile body. However, the present disclosure is not limited thereto, and the remote response request may be obtained, for example, from an entity other than the mobile body requiring remote response. The entity other than the mobile body may be, for example, a service server, a remote operation server, or the like, which requests remote response from an operator. The remote response request may be a request for a response operation by a remote operator. Examples of the service server include a delivery service server that requests remote response for transmitting an arrival notification to a user receiving a product after the product arrives at the delivery destination in a product delivery service. This makes it possible to determine the remote response order in consideration of the overall response operation by the remote operator.

In the information processing system according to the above embodiment and the like, when the system configuration requires a prior operation before the operator performs remote response, the system may be configured to perform the prior operation. The prior operation is exemplified by displaying an image of a vehicle to be remotely responded to on a dedicated screen for the remote response or by displaying the image in an enlarged manner, but the prior operation is not limited thereto. For example, the remote control server may automatically execute the prior operation a predetermined time period before the time at which the remote response by the operator is to be started. This enables a reduction in the number of operations required for the operator to perform. Note that performing the prior operation is an example of executing a predetermined process.

In the above embodiment and the like, in FIG. 3, an example has been described in which the determination in step S16 is executed when “no” is determined in step S14. However, the present disclosure is not limited thereto, and step S18 may be executed. That is, when response cannot be made possible even by adjusting the response order (“no” in S14), remote response planner 23 may determine a plan including an on-call response without including vehicle control (S18). For example, when determining that no remote response order exists, remote response planner 23 may transmit, as the predetermined process, to staff member terminal 40 of the on-call staff member, a notification requesting an on-call response.

In the above embodiment and the like, each component may be configured with dedicated hardware or implemented by executing a software program suitable for each component. Each of the components may be achieved by a program execution unit, such as a central processing unit (CPU) or a processor, reading and executing a software program recorded on a recording medium such as a hard disk or a semiconductor memory.

The order in which each step is executed in the flowchart is intended to specifically illustrate the present disclosure and may be an order other than the above order. Some of the above steps may be executed simultaneously (in parallel) with other steps, and some of the steps may not be executed.

The division of the functional blocks in the block diagram is an example, and a plurality of functional blocks may be implemented as one functional block, one functional block may be divided into a plurality of functional blocks, or some functions may be transferred to other functional blocks. The functions of a plurality of functional blocks having similar functions may be processed in parallel or in a time-divided manner by a single piece of hardware or software.

The remote control server according to the above embodiment and the like may be implemented as a single device or implemented by a plurality of devices. When remote control server 20 is implemented by a plurality of devices, the respective components of remote control server 20 may be distributed to the plurality of devices in any manner. When remote control server 20 is implemented by a plurality of devices, a communication method between the devices is not particularly limited and may be wireless or wired communication. Wireless and wired communications may be combined between devices. At least one function of remote control server 20 may be implemented by operator terminal 30 or a mobile body.

Each of the components described in the above embodiment and the like may be implemented as software or may be implemented as a large-scale integration (LSI), which is typically an integrated circuit. These may be individually integrated into one chip, or integrated into one chip to include some or all of them. The circuit is referred to as an LSI here but may also be called an integrated circuit (IC), system LSI, super LSI, or ultra LSI, depending on the degree of integration. The integrated circuit method is not limited to an LSI and may also be implemented using a dedicated circuit (a general-purpose circuit that executes a dedicated program) or a general-purpose processor. After manufacturing an LSI, a programmable field-programmable gate array (FPGA) or a reconfigurable processor that can reconfigure the connections or settings of circuit cells in the LSI may be used. Moreover, when an integrated circuit technology that replaces LSI appears due to advances in semiconductor technology or another derived technology, the components may naturally be integrated using such technology.

A system LSI is an ultra-multifunctional LSI manufactured by integrating a plurality of processors on a single chip and specifically refers to a computer system including a microprocessor, read-only memory (ROM), random-access memory (RAM), and the like. A computer program is stored in the ROM. The system LSI achieves its function by operating the microprocessor according to the computer program.

One aspect of the present disclosure may be a computer program that causes a computer to execute each of the characteristic steps included in the information processing method illustrated in one of FIGS. 3 and 9.

For example, the program may be a program for causing a computer to execute the steps. One aspect of the present disclosure may be a computer-readable non-transitory recording medium having such a program recorded thereon. For example, such a program may be recorded on a recording medium and then distributed or circulated. For example, by installing the distributed program in a device that includes another processor and causing the processor to execute the program, the device can be caused to perform each of the processes described above.

### INDUSTRIAL APPLICABILITY

The present disclosure is applicable to an information processing method for an operator to remotely control a mobile body.

1. An information processing method comprising:
obtaining remote response requests for a plurality of mobile bodies;
obtaining a response required time period and a response completion due time for each of two or more remote response requests that have not been responded to;
determining, for each of the two or more remote response requests, existence or non-existence of a remote response order in which a remote response to the remote response request can be completed by the response completion due time corresponding to the remote response request; and
executing, when the remote response order is determined to exist, a predetermined process on the two or more remote response requests based on the remote response order.

2. The information processing method according to claim 1,
wherein the two or more remote response requests include a first remote response request and a second remote response request, and
the information processing method further comprises:
obtaining a first response required time period and a first response completion due time for the first remote response request, and obtaining a second response required time period and a second response completion due time for the second remote response request;
determining, based on a first time at which the first remote response request can be notified and the first response required time period, whether a remote response to the first remote response request can be completed by the first response completion due time; and
determining, based on a second time at which the second remote response request can be notified and the second response required time period, whether a remote response to the second remote response request can be completed by the second response completion due time.

3. The information processing method according to claim 2,
wherein the second response completion due time is a time after the first response completion due time, and
the second time is a time specified based on the first time and the first response required time period.

4. The information processing method according to claim 2, further comprising:
determining, when the remote response order is determined to exist, existence or non-existence of remote response requests in the remote response order that can be swapped earlier or later; and
executing, when remote response requests that can be swapped earlier or later are determined to exist, the predetermined process simultaneously on the remote response requests that can be swapped earlier or later.

5. The information processing method according to claim 4, further comprising:
determining that the first remote response request and the second remote response request can be swapped earlier or later, when a time is earlier than each of the first response completion due time and the second response completion due time, the time being based on a time at which each of the first remote response request and the second remote response request can be notified and on a time period that is a sum of the first response required time period and the second response required time period.

6. The information processing method according to claim 1, further comprising:
transmitting, as the predetermined process, to a terminal device of an on-call staff member, a notification requesting an on-call response when the remote response order is determined not to exist.

7. The information processing method according to claim 1, further comprising:
determining, when the remote response order is determined not to exist, whether the remote response order exists assuming that a predetermined vehicle control is performed on one or more mobile bodies among the plurality of mobile bodies; and
executing, when the remote response order is determined to exist, the predetermined process for the two or more remote response requests and executing the predetermined vehicle control on the one or more mobile bodies, based on the remote response order.

8. The information processing method according to claim 7, further comprising:
excluding, from remote response requests on which the predetermined process is to be performed, the remote request obtained from the one or more mobile bodies; and
determining, based on the response required time period and the response completion due time for the remote response request for each of one or more other mobile bodies among the plurality of mobile bodies except for the one or more mobile bodies, existence or non-existence of the remote response order in which the remote response to the remote response request for each of the one or more other mobile bodies can be completed by the response completion due time for each of the one or more other mobile bodies.

9. The information processing method according to claim 7, further comprising:
further obtaining the response completion due time for each of the one or more mobile bodies when the predetermined vehicle control is performed on the one or more mobile bodies, the response completion due time further obtained being later than the response completion due time when the predetermined vehicle control is not performed; and
determining whether the remote response order exists based on the response completion due time further obtained for each of the one or more mobile bodies.

10. The information processing method according to claim 7,
wherein the predetermined vehicle control includes at least one of a route change instruction, a speed change instruction, or a stop instruction to the one or more mobile bodies.

11. The information processing method according to claim 7,
wherein, assuming that the predetermined vehicle control is performed on the one or more mobile bodies, when the remote response order is determined not to exist, a notification requesting an on-call response is transmitted to a terminal device of an on-call staff member as the predetermined process.

12. The information processing method according to claim 2, further comprising:
further obtaining, when an order of the first remote response request and the second remote response request is determined as the remote response order, a third remote response request after the predetermined process has been executed on the first remote response request;
obtaining a third response required time period and a third response completion due time for the third remote response request; and
updating the remote response order based on the second response required time period, the second response completion due time, the third response required time period, and the third response completion due time.

13. The information processing method according to claim 1,
wherein the plurality of mobile bodies include a mobile body configured to provide a predetermined service, and
the two or more remote response requests include a remote response request obtained from a server device that manages the predetermined service.

14. The information processing method according to claim 1,
wherein the two or more remote response requests include a remote response request generated based on operation information of the plurality of mobile bodies.

15. The information processing method according to claim 1,
wherein the predetermined process includes a process for causing a terminal device of an operator to present, based on the remote response order, a notification of each of the two or more remote response requests.

16. An information processing device comprising:
a first obtainer that obtains remote response requests for a plurality of mobile bodies;
a second obtainer that obtains a response required time period and a response completion due time for each of two or more remote response requests that have not been responded to among the remote response requests;
a determiner that determines, for each of the two or more remote response requests, existence or non-existence of a remote response order in which a remote response to the remote response request can be completed by the response completion due time corresponding to the remote response; and
a controller that executes, when the remote response order is determined to exist, a predetermined process on the two or more remote response requests based on the remote response order.

17. A non-transitory computer-readable recording medium having recorded thereon a program for causing a computer to execute the information processing method according to claim 1.
